(19) United States
(12) Patent Application Publication
(10) Pub. No.: US 2012/0302266 A1
(43) Pub. Date: Nov. 29, 2012

(54) COMMUNICATE AN INTERNET PROTOCOL ADDRESS TO A MOBILE PHONE

(76) Inventors: Ruth Ann Lim, Santa Clara, CA (US); Molly Joy, San Jose, CA (US)

(21) Appl. No.: 13/115,914

(22) Filed: May 25, 2011

(51) Int. Cl. H04W 4/14

(52) U.S. Cl. 455/466

(57) ABSTRACT

Embodiments disclosed herein relate to communicating an Internet Protocol address to a mobile phone. For example, an electronic device may create a message that includes the Internet Protocol address of the electronic device. The electronic device may transmit the message to an intermediary for communicating the message as a Short Message Service message to the mobile phone.

### BACKGROUND

Files may be stored on multiple electronic devices. For example, a user may store music files on a laptop computer and store additional music files on a mobile phone. Files may be transferred between electronic devices by using a portable storage device or directly connecting the devices for file transfer.

### BRIEF DESCRIPTION OF THE DRAWINGS

The drawings describe example implementations. The drawings show methods performed in an example order, but the methods may also be performed in other orders. The following detailed description references the drawings, wherein:

FIG. 1 is a block diagram illustrating one example of a computing system.

FIG. 2 is a flow chart illustrating one example of a method to communicate an Internet Protocol address to a mobile phone.

FIG. 3 is a diagram illustrating one example of communicating an Internet Protocol address to a mobile phone.

FIG. 4 is a flow chart illustrating one example of a method to create an email message to communicate an Internet Protocol address to a mobile phone.

FIG. 5 is a diagram illustrating one example of creating an email message to communicate an Internet Protocol address to a mobile phone.

FIG. 6 is a flow chart illustrating one example of communicating an Internet Protocol address to a mobile phone.

### DETAILED DESCRIPTION

It may be desirable for a user to exchange data between multiple electronic devices. For example, a user may want to sync files between a laptop and a mobile phone. The user may be able to plug the mobile phone into the electronic device with a Universal Serial Bus (USB) cable, use a portable storage device for temporarily storing files until copied to the other device, or cause the devices to communicate with one another using a short distance communication protocol, such as Bluetooth®. It may be more convenient for a user to transfer files over a faster, longer distance network, such as transferring files over the Internet using a wireless or cellular data network. To transfer files over the Internet, one of the devices may use the Internet Protocol (IP) address of the other device for an initial communication. A user may manually configure devices to communicate by entering the Internet Protocol address of one of the devices along with additional information. However, a user may not have the technical knowledge to determine the Internet Protocol address of the device or to configure the devices to communicate with one another.

To address this problem, an automated system allows a user without knowledge of an electronic device Internet Protocol address and without knowledge of a device to device communication configuration process to establish a communication link for data exchange between an electronic device and a mobile phone. For example, an electronic device may format a message including the electronic device's Internet Protocol address to an intermediary with access to a Short Message Service (SMS) gateway for transmitting the contents of the message to a mobile phone in the form of a Short Message Service message. The intermediary may be, for example, a service or company associated with the mobile phone, such as a phone service provider to the mobile phone.

The mobile phone may analyze the received Short Message Service message to extract the Internet Protocol address. The mobile phone may then initiate communication with the electronic device using the Internet Protocol address received in the Short Message Service message. The two devices may exchange data after communication is set up.

Having an electronic device automatically perform setup for exchanging data with a mobile phone may make data exchange over the Internet more accessible to users unfamiliar with a manual configuration process. In addition, having an electronic device send a Short Message Service message through an intermediary allows the electronic device to communicate with the mobile phone without the electronic device having access to a Short Message Service gateway for transmitting the Short Message Service message.

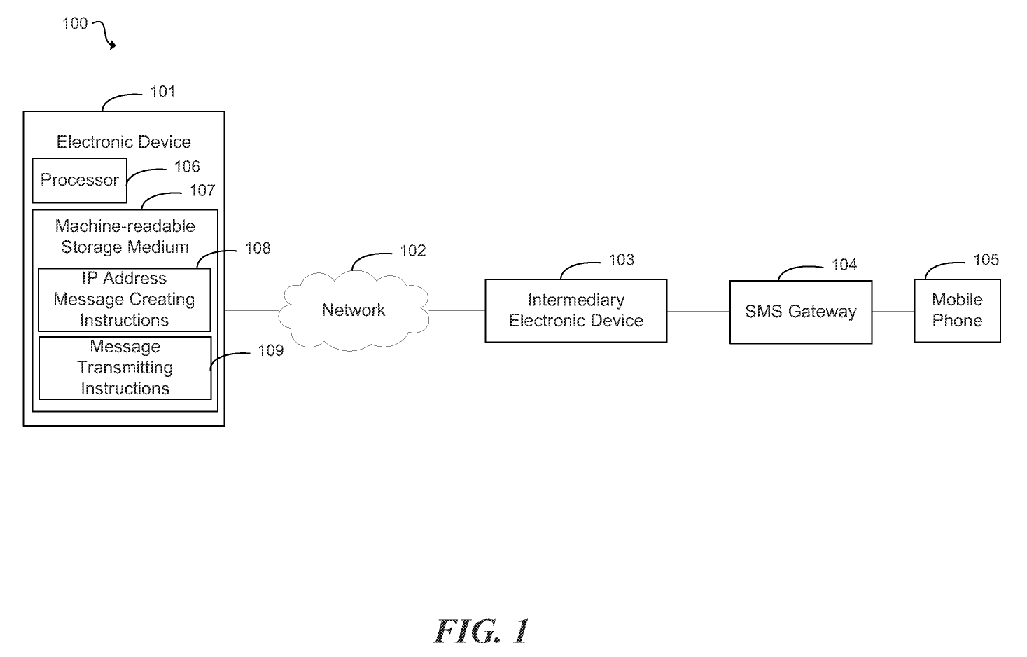

FIG. 1 is a block diagram illustrating one example of a computing system 100. The computing system 100 includes an electronic device 101, a network 102, an intermediary electronic device 103, a Short Message Service Gateway 104, and a mobile phone 105. The electronic device 101 may be, for example, a personal computer. The electronic device 101 may be a desktop, laptop, or slate computer. In some cases, the electronic device 101 may not have Short Message Service messaging capabilities.

The electronic device 101 may include a processor 106 and a machine-readable storage medium 107. The processor 106 may be any suitable processor, such as a central processing unit (CPU), a semiconductor-based microprocessor, or any other device suitable for retrieval and execution of instructions. In one implementation, the electronic device 101 includes logic instead of or in addition to the processor 106. As an alternative or in addition to fetching, decoding, and executing instructions, the processor 106 may include one or more integrated circuits (ICs) (e.g., an application specific integrated circuit (ASIC)) or other electronic circuits that comprise a plurality of electronic components for performing the functionality described below. In one implementation, the electronic device 101 includes multiple processors. For example, one processor may perform some functionality and another processor may perform other functionality described below.

The machine-readable storage medium 107 may be any suitable machine readable medium, such as an electronic, magnetic, optical, or other physical storage device that stores executable instructions or other data (e.g., a hard disk drive, random access memory, flash memory, etc.). The machine-readable storage medium 107 may be, for example, a computer readable non-transitory medium. The machine-readable storage medium 107 may include instructions executable by the processor 106.

The machine-readable storage medium 107 may include Internet Protocol address message creating instructions 108 and message transmitting instructions 109. The Internet Protocol address message creating instructions 108 may include instructions executable by the processor 106 for creating a message for communicating the Internet Protocol address of the electronic device 101. The Internet Protocol address may be an address for communicating with the electronic device 101 across the Internet. The Internet Protocol address may be included in a message intended for an intermediary capable of sending the contents of the message to a mobile phone via a Short Message Service gateway. In one implementation, the message is an email message. The Internet Protocol address message creating instructions 108 may include instructions for formatting the message in a particular manner, such as a format that may be interpreted by the mobile phone 105 to extract the Internet Protocol address.

The message transmitting instructions 109 may include instructions to transmit the message to the intermediary electronic device 103 via the network 102. For example, the electronic device 101 may include a network interface for communicating with the network 102 so that the electronic device 103 may transmit an email or other message type including the Internet Protocol address information of the electronic device 101.

The network 102 may be any suitable network, such as the Internet. The intermediary electronic device 103 may be, for example, an electronic device capable of communicating with a Short Message Service gateway for transmitting a Short Message Service message to a mobile phone. The intermediary electronic device 103 may be an electronic device owned by a mobile phone service provider or other entity. The intermediary electronic device 103 may allow an electronic device without Short Message Service capabilities to send a different message type, such as an email, to the intermediary electronic device 103 for the intermediary electronic device 103 to convert into a Short Message Service message.

The intermediary electronic device 103 may be used to check a message account, such as an email account, and forward the message contents to mobile phones using the Short Message Service gateway 104. The Short Message Service gateway 104 may be, for example, a device for sending a Short Message Service message to a mobile phone without the use of a mobile phone. The Short Message Service gateway 104 may send the message transmitted from the electronic device 101 to the mobile phone 105.

The mobile phone 105 may be, for example, a smart phone with processing power and Short Message Service capabilities. The mobile phone 105 may parse the received Short Message Service message to determine the Internet Protocol address of the electronic device 101. For example, the message may be in a proprietary format known to both the electronic device 101 and the mobile phone 105. The mobile phone 105 may begin a communication process with the electronic device 101 using the Internet Protocol address from the message. The electronic device 101 and the mobile phone 105 may then exchange data via the network 102 after the communication link is established.

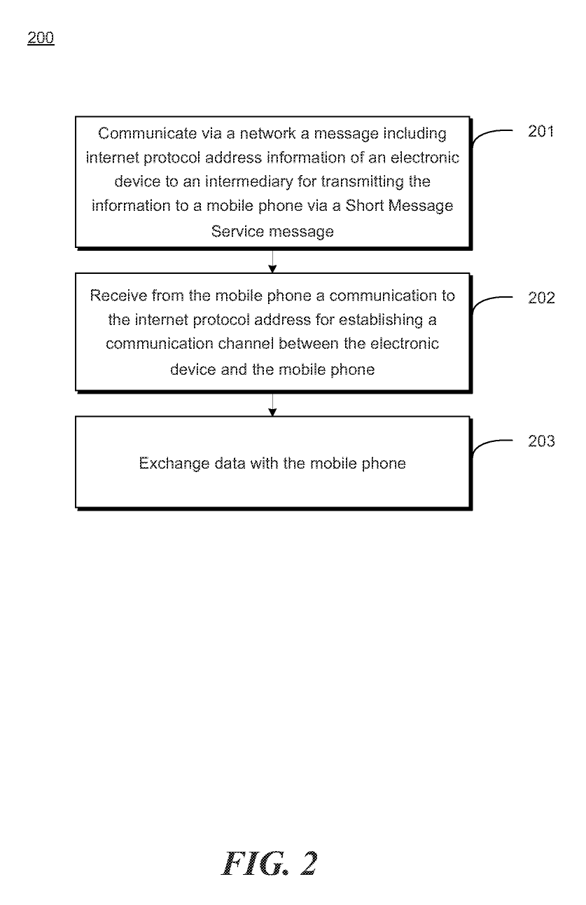

FIG. 2 is a flow chart 200 illustrating one example of a method to communicate an Internet Protocol address to a mobile phone. For example, an electronic device may receive information from user input about a mobile phone selected to exchange data with the electronic device. The electronic device may initiate communication with the mobile phone by sending a message with the electronic device's Internet Protocol address to an intermediary that converts the message to a Short Message Service message and sends it to the mobile phone. The mobile phone may extract the Internet Protocol address from the Short Message Service message and use the Internet Protocol address to begin communicating with the electronic device. The mobile phone and electronic device may then begin to exchange data. The method may be implemented, for example, by the electronic device 101 of FIG. 1.

Beginning at 201, a processor communicates via a network a message including internet protocol address information of an electronic device to an intermediary for transmitting the information to a mobile phone via a Short Message Service message. The processor may generate the message based on a particular format. For example, the mobile phone may have a type of software installed on it for interpreting a Short Message Service message with a particular format, and the processor may create the message in this format. The format may include some authentication information or other information in addition to the Internet Protocol address of the electronic device.

In one implementation, the processor creates the message in response to user input. For example, a user interface displayed on a display device associated with the electronic device may allow a user to enter a mobile phone number of a mobile phone that a user wants to share data with the electronic device. Additional information may be entered into the user interface, such as information for determining an appropriate intermediary to receive the message. For example, a user may enter a mobile phone service provide associated with the mobile phone, and the intermediary may be associated with the mobile phone service provider. The processor may then create the message based on the information received from the user input. In one implementation, information from the user input may be stored for subsequent use. For example, a user may select a mobile phone from a list of mobile phones for which information is stored and cause the processor to generate a message for the selected mobile phone.

The processor may electronically transmit the message via a network, such as the Internet, to the intermediary. The intermediary may be an entity for transmitting the message as a Short Message Service message. The intermediary may be, for example, associated with a mobile phone service provider. In one implementation, the processor determines an address for the message recipient. The address may be determined based on the mobile phone number or other information. In one implementation, the message is an email message sent to an email recipient address determined based on the mobile phone number and the mobile phone service provider.

In some cases, the processor may send additional messages to the intermediary to forward to the mobile phone. The processor may send information about the status of the processor to the intermediary to provide information to the mobile phone about when the electronic device may be contacted. For example, the processor may send information to the mobile phone that the electronic device is going offline to provide notice to the mobile phone that an attempt to communicate with the electronic device may be unsuccessful.

Continuing to 202, the processor receives from the mobile phone a communication to the Internet Protocol address for establishing a communication channel between the electronic device and the mobile phone. The mobile phone may be a smart phone capable of analyzing a Short Message Service message received from the intermediary. For example, the intermediary may forward the contents of the message from the electronic device to the mobile phone in the form of a Short Message Service message, and the mobile phone may analyze the message contents to extract the Internet Protocol address information. The mobile phone may initiate contact with the electronic device using the Internet Protocol address extracted from the Short Message Service message. The electronic device may receive the communication from the mobile phone, and the electronic device and the mobile phone may begin a handshake communication process after the mobile phone initiates communication with the electronic device.

Proceeding to 203, the processor exchanges data with the mobile phone. The processor may send data to the mobile phone or may receive data from the mobile phone. The data may be any suitable data, such as media, word processing, or other types of data. In one implementation, the mobile phone and processor automatically sync data, such as based on a setting of a location or file type to sync. In some implementations, the electronic device causes a user interface to be displayed on a display device associated with the electronic device to allow a user to select which items to retrieve from the mobile phone or to send to the mobile phone.

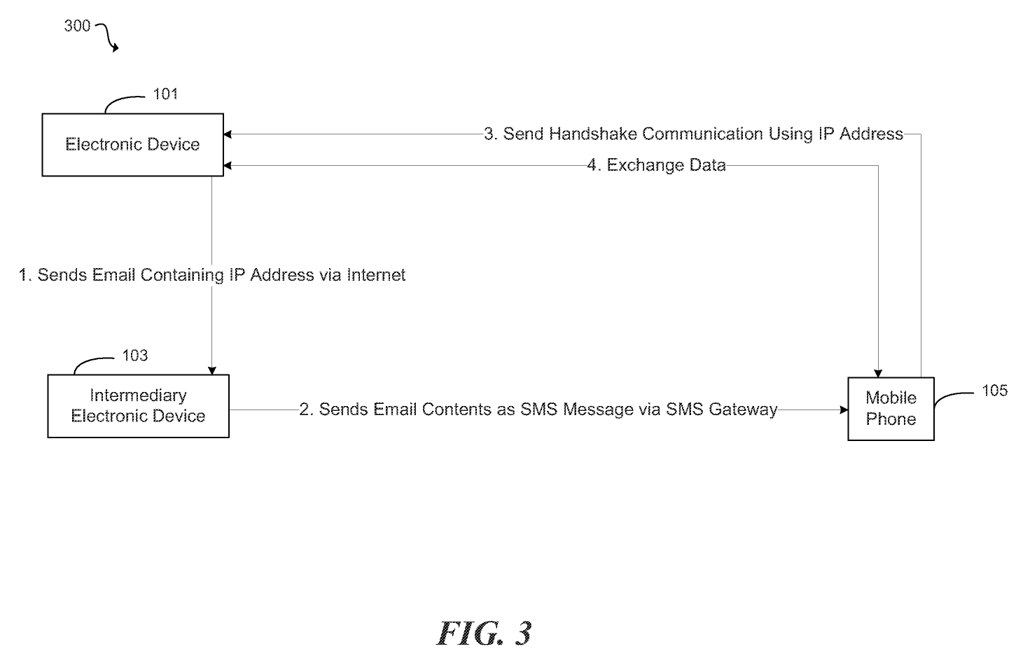

FIG. 3 is a block diagram 300 illustrating one example of communicating an Internet Protocol address between an electronic device and a mobile phone. The block diagram 300 includes the electronic device 101, the intermediary electronic device 103, and the mobile phone 105. First, the electronic device sends an email containing the Internet Protocol address of the electronic device 101 to the intermediary electronic device 103 via the internet. Then, the intermediary electronic device 103 sends the email contents, including the Internet Protocol address information, to the mobile phone 105 using a Short Message Service gateway. The mobile phone 105 then starts a handshake communication process with the electronic device 101 using the Internet Protocol address from the received Short Message Service message. The electronic device 101 and the mobile phone 105 may then begin exchanging data.

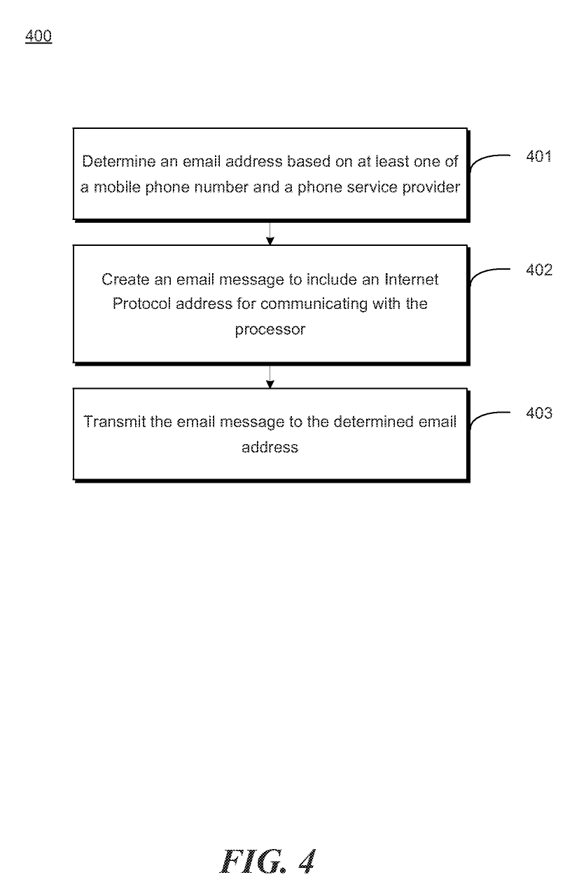

FIG. 4 is a flow chart illustrating one example of a method to create an email message to communicate an Internet Protocol address to a mobile phone. For example, an email message may be sent to an intermediary that forwards the email contents to a mobile phone as a Short Message Service message via a Short Message Service gateway. A processor may determine the email address based on a mobile phone number and a phone service provider. The processor may create a message to the email address that includes the Internet Protocol address of the electronic device associated with the processor. The processor may then transmit the email message to the email address. The email address may be associated with an intermediary, such as a mobile phone service provider, that then forwards the email contents, including the Internet Protocol address information, to the mobile phone as a Short Message Service message.

Beginning at 401, a processor determines an email address based on at least one of a mobile phone number and a phone service provider. For example, the email address may be associated with a service for forwarding the email contents as a Short Message Service to a mobile phone associated with the mobile phone number. The processor may receive a mobile phone number and a phone service provider and determine an email address based on a method or lookup table. For example, the processor may create an email including the mobile phone number at a domain associated with the phone service provider. The processor may retrieve information about an email domain associated with the phone service provider. In some cases, the processor may retrieve information about an email address format associated with the phone service provider. For example, a phone service provider may have a set email where the subject line includes the mobile phone number. The mobile phone number may be included to identify the Short Message Service account to forward the email contents.

Continuing to 402, the processor creates an email message to include an Internet Protocol address for communicating with the processor. The processor may create the email message in a particular format. For example, in some cases, the electronic device associated with the processor and the mobile phone may be created by the same company or by partnering companies such that the processor creates the email in a proprietary format, and the mobile phone includes software for parsing the email in the proprietary format to extract the Internet Protocol address information. The processor may create an email message with the Internet Protocol address included in the body of the email. In some cases, additional information may also be included in the body of the email, such as authentication information.

Proceeding to 403, the processor transmits the email message to the determined email address. For example, the processor may transmit the email message via the Internet using a network interface. The email recipient may be, for example, a recipient associated with a phone service provider to the mobile phone. The phone service provider may have an email account for forwarding Short Message Service messages to mobile phone subscribers. For example, the phone service provider may have a user interface for the purpose of creating the email or allow messages sent to the email to be forwarded as Short Message Service messages. This functionality may be used for devices without Short Message Service capabilities for sending Short Message Service messages.

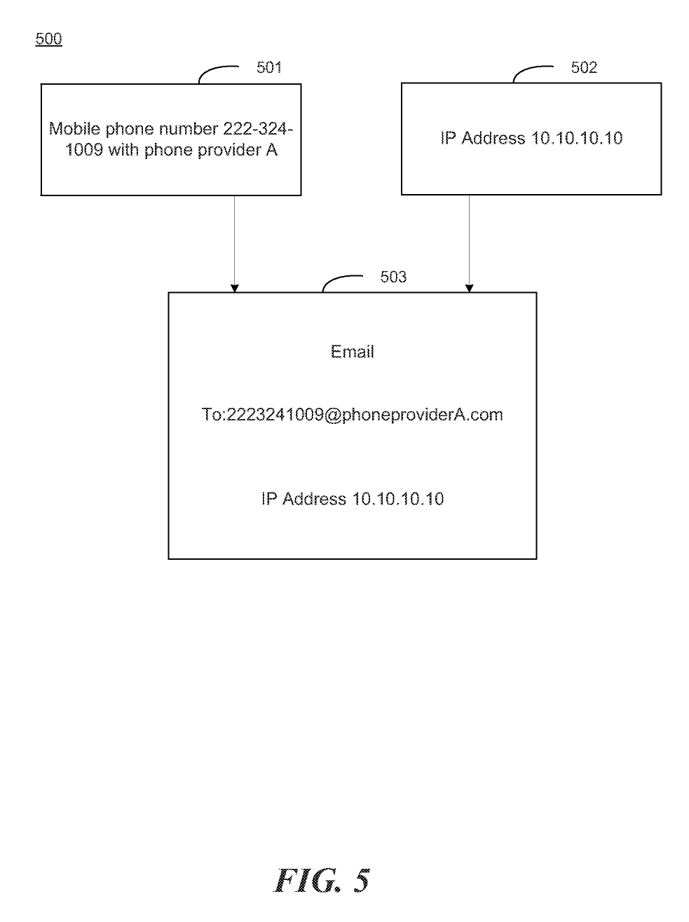

FIG. 5 is a diagram illustrating one example of creating an email message to communicate an Internet Protocol address to a mobile phone. The email message may be sent to an intermediary. The intermediary may be, for example, a mobile phone service provider. Information about the intermediary may be included, for example, in recipient information for the message or in the body of the message. In one implementation, the recipient information also includes information about the targeted mobile phone. The targeted mobile phone number may be included within the body of the message. The message may be generated, for example, by the electronic device 101.

The diagram 500 shows an input 501 including a mobile phone number and phone provider. The information may be entered by a user into a user interface generated by an electronic device and displayed on a display device associated with the electronic device. In some implementations, the electronic device may store the information such that future communications links may be created without the user input. The electronic device may retrieve its own Internet Protocol address such that a user does not input the information. For example, the input 502 of the Internet Protocol address may be retrieved by the electronic device.

The email 503 shows a recipient of 2223241009@phoneproviderA.com, which corresponds to the provided mobile phone number with an email to a Short Message Service gateway of phone provider A. For example, the email may be [10DigitPhoneNumber]@phoneproviderA.com. In some implementations, the electronic device 101 may receive information about the phone provider, such as through a user interface, and retrieve the related Short Message Service gateway email information from a storage such that the user inputs or selects the phone provider name instead of the email information, which may be easier for a user to remember. The body of the email 503 includes the Internet Protocol address for the electronic device. In some cases, the body of the email may include special formatting corresponding to formatting that may be parsed by a mobile phone. The formatting may be a proprietary format. For example, an electronic device of a particular type may be able to communicate with a particular brand of mobile phone aware of the proprietary formatting. The proprietary formatting may be used so that the mobile phone may verify that the Internet Protocol address is associated with a trusted source.

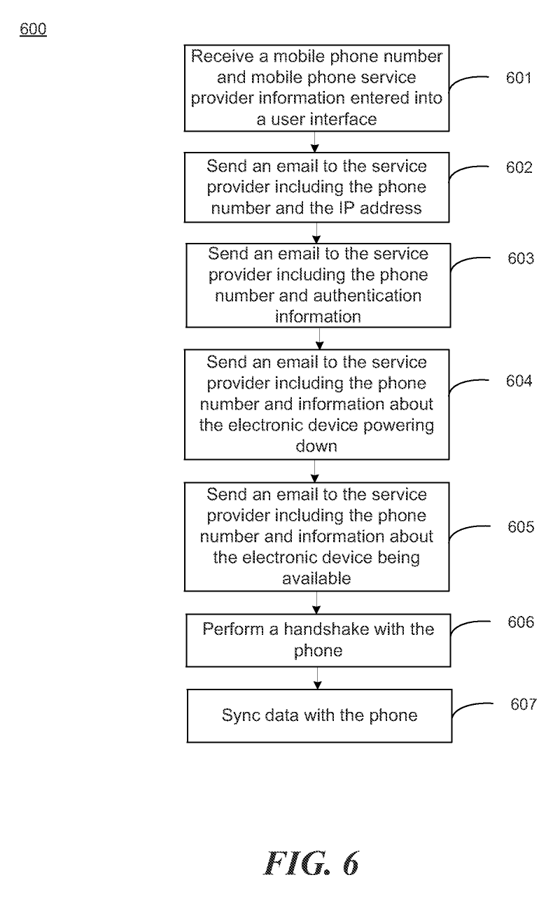

FIG. 6 is a flow chart illustrating one example of communicating an Internet Protocol address to a mobile phone. For example, the electronic device 101 may communicate Internet Protocol address information to the mobile phone 105. At 601, an electronic device receives a mobile phone number and the associated phone service provider information for the mobile phone number. The information may be received, for example, from user input into a user interface. At 602, the electronic device sends an email to the phone service provider including the mobile phone number and the Internet Protocol address of the electronic device. For example, the recipient email address information may include the mobile phone number and the phone service provider domain, and the body of the email may include the Internet Protocol address of the electronic device.

At 603, the electronic device sends another email to the phone service provider including authentication information. In some implementations, the authentication information may be in the original email including the Internet Protocol address. In some implementations, the authentication email may be sent prior to sending the email with the Internet Protocol address.

At 604, the electronic device sends information in an email to the phone service provider about the targeted mobile phone and status information indicating that the electronic device is powering down. This may be done to prevent the mobile phone from starting a communication with the electronic device when the electronic device is not available. If the communication link has not been established, the electronic device may not be able to directly communicate the information to the mobile phone. At 605, the electronic device sends information to the phone service provider about the targeted mobile phone and status information indicating that the electronic device is available. In some implementations, the electronic device may send the Internet Protocol address information again instead of or in addition to sending status availability information.

At 606, the electronic device performs a handshake process with the mobile phone. The process may begin with the mobile phone contacting the Internet Protocol address received in a Short Message Service message from the phone service provider. At 607, the electronic device synchronizes data with the mobile phone. For example, a user interface may allow a user to transfer or copy specific files between the devices or may include a setting for automatically syncing particular file types or files stored in a particular location.

Generating a message for an intermediary to forward to a mobile phone as a Short Service Message provides a simple method for communicating Internet Protocol information. As a result, a user with little technical knowledge may be able to establish communication between an electronic device and a mobile phone to exchange data between the two devices.

1. A method, comprising:
causing a user interface to be displayed to capture a mobile phone number of a mobile phone to receive a Short Message Service message including an Internet Protocol address of an electronic device without Short Message Service capabilities to exchange data with the mobile phone;
determining, by a processor, an email address based on the mobile phone number, wherein the email address is associated with a service for forwarding the email contents as a Short Message Service message to the mobile phone;
creating, by a processor, an email message to include the Internet Protocol address for communicating with the electronic device; and
transmitting, by a processor, the email message to the determined email address.

2. The method of claim 1, further comprising receiving, by the mobile phone, the email message including the Internet Protocol address.

3. The method of claim 2, further comprising exchanging data with the mobile phone.

4. The method of claim 1, further comprising causing a user interface to be displayed to receive information about the phone service provider associated with the mobile phone.

5. The method of claim 1, further comprising sending a second email including an updated interne protocol address of the electronic device to the determined email address.

6. The method of claim 1, wherein creating the email message comprises creating the message in a format interpretable by the mobile phone.

7. A system, comprising:
a processor to:
cause a user interface to be displayed to capture a mobile phone number of a mobile phone to receive a Short Message Service message of an Internet Protocol address of a processor to exchange data with the mobile phone, wherein the processor does not include Short Message Service capabilities;
create an electronic message including of the Internet Protocol address for communicating with the processor;
transmit the message via a network to an intermediary for communicating the message via a Short Message Service gateway to a Short Message Service account associated with the mobile phone number.

8. The system of claim 7, wherein the message comprises an email message.

9. The system of claim 7, wherein transmitting the message to an intermediary electronic device comprises transmitting the message to a phone service provider for the mobile phone.

10. The system of claim 7, wherein the message includes authentication information.

11. The system of claim 7, wherein the processor further:
receives a communication from the mobile phone; and
exchanges data with the mobile phone.

12. The system of claim 7, wherein the mobile phone:
parses the Short Message Service message received from the intermediary to extract the internet protocol address; and
sends a communication to the processor using the extracted interact protocol address.

13. A machine-readable non-transitory storage medium comprising instructions executable by a processor to:
cause a user interface to be displayed to capture a mobile phone number to receive a) Message Service message;
communicate via a network a message including interact protocol address information of an electronic device without Short Message Service capabilities to an intermediary for transmitting, the information to a mobile phone associated with the mobile phone number via the Short Message Service message;
receive from the mobile phone a communication to the internet protocol address for establishing a communication channel between the electronic device and the mobile phone; and
exchange data with the mobile phone.

14. The computer readable non-transitory storage medium of claim 13, further comprising instructions to communicate state information related to the electronic device with the intermediary.

15. The computer readable non-transitory storage medium of claim 13, wherein instructions to communicate a message comprise instructions to communicate an email message.
